(19) United States
(12) Patent Application Publication
(10) Pub. No.: US 2026/0101298 A1
(43) Pub. Date: Apr. 9, 2026

(54) SYSTEMS AND METHODS FOR A USER EQUIPMENT TO RECEIVE OR REQUEST ON-DEMAND INFORMATION VIA OTHER CELLS

(71) Applicant: Telefonaktiebolaget LM Ericsson (PUBL), Stockholm (SE)

(72) Inventors: Sina Maleki, MALMÖ (SE); Ali Nader, MALMÖ (SE); Pål Frenger, LINKÖPING (SE); Andres Reial, HÖLLVIKEN (SE)

(21) Appl. No.: 19/115,376

(22) PCT Filed: Sep. 29, 2023
(86) PCT No.: PCT/EP2023/077135

§ 371 Date: Mar. 26, 2025

Related U.S. Application Data
(60) Provisional application No. 63/377,544, filed on Sep. 29, 2022.

(51) Int. Cl. H04W 56/00; H04L 5/00; H04W 16/28

(52) U.S. Cl. CPC H04W 56/0015; H04L 5/0051; H04W 16/28

(57) ABSTRACT

A method for receiving on-demand information by a user equipment, UE, served by a first network node associated with a first cell includes obtaining an indication of whether to request the on-demand information for a second cell from a first network node associated with a first cell or a second network node associated with a second cell. Based on the indication, the UE transmits, to the first network node or the second network node, a request for the on-demand information for the second cell. The UE receives the on-demand information for the second cell.

### TECHNICAL FIELD

The present disclosure relates, in general, to wireless communications and, more particularly, systems and methods for a User Equipment (UE) to receive or request on-demand information via other cells.

### BACKGROUND

Network (NW) energy consumption in New Radio (NR) increases with respect to Long Term Evolution (LTE) due to more complex hardware (HW) such as, for example, higher bandwidth (BW) and a greater number of antennas. This is particularly evident when the NW operates in higher frequencies. As such, it is important for the NW to turn ON/OFF unused HW modules during inactive times.

For example, in Frequency Range 2 (FR2), an NR gNodeB (gNB) can be configured with up to 64 beams and transmit up to 64 SSBs. This implies 64 ports with many transceiver chains involved. Such Synchronization Signal Blocks (SSBs) are transmitted every 20 ms during 5 ms windows for the sake of providing coverage to potential UEs even when there actually are no UEs present in the cell. Another example of always-on broadcast transmissions is System Information Block-1 (SIB1), which is typically transmitted (per beam) every 20/40 ms and is also energy costly.

### SSB and SIB1 Configurations

As described above, an NR gNB can be configured with up to 64 SSBs. All of the configured SSBs in a cell for UEs in the Radio Resource Control (RRC) IDLE/INACTIVE have the same periodicity and output power. The gNB can provide information to the UEs about how many and/or which SSBs are active within the serving cell and neighboring cells. The SSB consists of a primary synchronization signal (PSS), a secondary synchronization signal (SSS), and the physical broadcast channel (PBCH).

The gNB can further provide information about the rate/periodicity at which these SSBs are provided on a cell level. For the serving cell, the parameter ssb-PositionsInBurst indicates which of the SSBs are active, and the parameter ssb-PeriodicityServingCell specifies the rate/periodicity of the active SSBs. Furthermore, the UEs are informed about the SSBs output power via the common parameter ss-PBCH-BlockPower.

When it comes to neighboring cells, a gNB can specify the neighboring active SSBs via the parameter ssb-ToMeasure and the associated rate/periodicity via the SSB Measurement Timing Configuration (SMTC), which defines the time window during which the UE measures the SSBs belonging to these neighboring cells.

The UE makes certain assumptions for a standalone NR cell upon the cell selection procedure. Even though the periodicity of the SSB is configurable, upon initial cell selection, the UE expects that the SSB is provided every 20 ms in that cell. Furthermore, the UE expects that SIB1 is transmitted in every beam (corresponding to every SSB) of the cell. For example, for a 64-beam/SSB configuration, the UE expects that SIB1 is broadcast/swept in 64 beams. The transmission period of SIB1 is typically between 20-40 ms. Thus, for example, every 20 ms, 64 instances of SIB1 is transmitted by the gNB. The master information block (MIB) is part of the SSB. Together with SIB1 they are called Minimum System Information (Minimum SI). If the UE cannot determine the full contents of the minimum SI of a cell by receiving from that cell, the UE shall consider that the cell is barred.

Other system information (OSI) may include SI other than SIB1. For example, OSI may include SIBs 2, 3, etc. The OSI is carried in SI containers, which are also broadcast in a similar manner per beam. However, for the serving cell, the gNB may choose not to constantly transmit SI and either transmit these in dedicated messages to the UEs when in connected mode or let the UEs ask for SI provision on demand. Depending on the gNB's configuration, the on-demand request from UE may either be done through random access specific resources or higher layer signaling. Regardless, UEs are informed via SIB1 that the current cell is broadcasting or can broadcast SI on-demand. See, 3GPP 38.331, SchedulingInfo→si-BroadcastStatus→ENUMERATED{broadcasting, notBroadcasting}.

UEs are configured with the above SSB/SIB1/SI presence and timing/rate information either in RRC_IDLE/INACTIVE via broadcast system information or in RRC_Connected via dedicated RRC messages. In IDLE/INACTIVE, the ssb-PositionsInBurst and ssb-PeriodicityServing for serving cell is configured via SIB1 and the SMTC configurations for neighboring cells are provided in SIB2/SIB4 contained in SI messages.

For the sake of energy savings, there are discussions in a 3GPP Rel-18 NW energy efficiency study item about having cells that do not transmit SSBs or SIB1/SI. Instead, there is a coverage/overlapping cell that broadcasts SIB1/SI for the underlying cells, and the UEs may acquire the information from the coverage cell instead.

### Master Information Block (MIB)

The MIB is transmitted the message part of the PBCH, which is a part of the SSB, and it contains the following information:

| | |
|---|---|
| MIB ::= | SEQUENCE { |

| | |
|---|---|
| systemFrameNumber | BIT STRING (SIZE (6)), |
| subCarrierSpacingCommon | ENUMERATED {scs15or60, |

scs30or120},

| ssb-SubcarrierOffset | INTEGER (0..15), |
|---|---|
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, |
| | notAllowed}, |

| | |
|---|---|
| spare | BIT STRING (SIZE (1)) |

}

In addition to the MIB content, the SSB also provides the UE with a physical cell ID (derived from the sequence indexes of the PSS and SSS) and an SSB-Index (derived from the sequence index of the DM-RS transmitted in the PBCH).

There currently exist certain challenge(s), however. For example, as discussed above, existing techniques and discussions relate to SSB/MIB/SIB1/OSI-less cells where a UE may acquire synch for one cell from another cell's SSB such as, for example a coverage cell's SSB) or acquire corresponding SIB1/OSI or MIB from another cell. Nevertheless, this implies that the coverage cell may potentially be overloaded by MIB/SIB1/OSI transmissions for the sake of other cells, especially if multiple cells are covered. Furthermore, the details of such methods and techniques have not been discussed. Therefore, there is a need for detailed design of such methods and mechanisms in an energy efficient manner.

### SUMMARY

Certain aspects of the disclosure and their embodiments may provide solutions to these or other challenges. For example, according to certain embodiments, systems and methods are provided for a UE that is served by a first network node associated with a first cell to receive on-demand information for a second cell.

According to certain embodiments, a method for receiving on-demand information by a UE served by a first network node associated with a first cell includes obtaining an indication of whether to request the on-demand information for a second cell from a first network node associated with a first cell or a second network node associated with a second cell. Based on the indication, the UE transmits, to the first network node or the second network node, a request for the on-demand information for the second cell. The UE receives the on-demand information for the second cell.

According to certain embodiments, a UE for receiving on-demand information is provided. The UE is served by a first network node associated with a first cell. The UE is adapted to obtain an indication of whether to request the on-demand information for a second cell from a first network node associated with a first cell or a second network node associated with a second cell. Based on the indication, the UE is adapted to transmit, to the first network node or the second network node, a request for the on-demand information for the second cell. The UE is adapted to receive the on-demand information for the second cell.

According to certain embodiments, a method for transmitting on-demand information by a first network node associated with a first cell includes receiving a request for on-demand information for a second cell. The request is received from a UE or a second network node associated with the second cell. The first network node performs at least one of: transmitting the on-demand information for the second cell to the UE, and transmitting, to the second network node associated with the second cell, an indication to send the on-demand information for the second cell to the UE.

According to certain embodiments, a first network node associated with a first cell is provided for transmitting on-demand information. The first network node is adapted to receive a request for on-demand information for a second cell. The request is received from a UE or a second network node associated with the second cell. The first network node is adapted to perform at least one of: transmitting the on-demand information for the second cell to the UE, and transmitting, to the second network node associated with the second cell, an indication to send the on-demand information for the second cell to the UE.

According to certain embodiments, a method for transmitting on-demand information by a second network node associated with a second cell includes receiving a request to transmit on-demand information for the second cell for a UE served by a first network node in a first cell. The request is received from the UE or the first network node associated with the first cell. The second network node performs at least one of: transmitting the on-demand information for the second cell to the UE, and transmitting, to the first network node associated with the first cell, an indication that the first network node is transmit the on-demand information for the second cell.

According to certain embodiments, a second network node associated with a second cell is provided for transmitting on-demand information. The second network node is adapted to receive a request to transmit on-demand information for the second cell for a UE served by a first network node in a first cell. The request is received from the UE or the first network node associated with the first cell. The second network node is adapted to perform at least one of: transmitting the on-demand information for the second cell to the UE, and transmitting, to the first network node associated with the first cell, an indication that the first network node is transmit the on-demand information for the second cell.

Certain embodiments may provide one or more of the following technical advantage(s). For example, certain embodiments may provide a technical advantage of enabling a second network node on which the UE is camping to go into deeper sleep modes than micro sleep, if there is nothing to be transmitted, because the second network node is not required to transmit one or more of SSB/SIB1/MIB or other SIBs. Instead, in one example, a first network node (e.g., with overlapping cells) can transmit the on-demand information without being constantly overloaded thanks to certain embodiments and techniques described herein.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an exemplary deployment that includes a coverage gNB associated with a first cell that overlaps one or more capacity nodes and their corresponding cells, according to certain embodiments;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates a method by a UE for receiving on-demand information, according to certain embodiments;

FIG. 9 illustrates a method for transmitting on-demand information by a first network node associated with a first cell, according to certain embodiments; and

FIG. 10 illustrates a method for transmitting on-demand information by a second network node associated with a second cell, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of anode is user equipment (UE), which is anon-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc. Where a specific term is indicated (e.g., gNB), it is recognized that any other network node may perform the same functionality. Accordingly, such terms are not considered limiting.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to certain embodiments that are described in more detail below, systems and methods are provided for a UE being configured for at least a first cell that is a serving cell and at least one additional cell (e.g., a second cell). With regard to at least the second cell, the UE may not be configured to receive at least one of the periodic SSB or SIB1 or MIB or other SI, in certain embodiments. However, the UE may additionally be configured to receive, from another cell, namely the first cell, the corresponding SIB1 or MIB or other SI related to the second cell.

In a particular embodiment, if the UE is not configured to receive periodic SSB on the second cell, the UE will also not receive SIB1 or other SIBs/SI.

In a particular embodiment, the UE is only configured to receive a “light” SSB-alike signal (e.g., without parts of the MIB or a full MIB) on the second cell. In this case, the partial MIB or full MIB is transmitted on the first cell, if the intention is to transmit a MIB for this cell. In a similar way, SIB1 or other SI/SIBs may be transmitted on the first cell.

In another particular embodiment, the UE receives and/or is configured to receive SSB on the second cell, but is not configured to receive SIB1 or other SI on the second cell. SIB1/other SI, if configured for the second cell, is transmitted on the first cell.

In a particular embodiment, the UE camps on the second cell despite that the second cell is not providing the SSB/minimum SI and other essential system information. The UE knows that the corresponding information may be retrieved from a first cell based on one or more of:
specific characteristics of a reference signal in the second cell (e.g., specific type of SSB such as a light-weight SSB,
an indicator in the MIB part of the SSB,
a light weight MIB with the minimum information required transmitted along the light weight SSB, and/or
a SIB transmitted over the first cell, e.g., an energy saving SIB.

In any particular embodiment, the UE may be additionally configured to ask for on-demand SSB, SIB1, or MIB to be transmitted from the second cell such as, for example, from a second network node associated with the second cell.

In a particular embodiment, the UE asks and/or is configured to ask for one or more of on-demand SSB, SIB1, MIB or other SIBs to be transmitted from a first cell such as, for example, from a first network node associated with the first cell. In another particular embodiment, the first cell provides one or more of the information (SSB/MIB/SIB1/OSI) itself on behalf of the second cell. In one example, the UE transmits the demand to the second node over the resources which are pre-configured for the UE, or that the UE has received the configuration (e.g., through higher layer signaling or L1/L2 signaling) from the first cell such as for example from a first network node associated with the first cell.

In yet another particular embodiment, a first network node associated with the first cell asks a second network node associated with the second cell to provide one or more of the information (e.g., SSB, MIB, SIB1, and/or OSI). For example, a first network node associated with the first cell may transmit, to a second network node associated with the second cell, a request for the SSB, MIB, SIB1, and/or OSI.

In a further particular embodiment, in response to a UE demand, the second cell starts transmitting SSB, MIB, SIB1, and/or OSI on the second cell and the first cell stops its transmission (based on NW inter-cell communication), if it was transmitting them, and the UE receives SIB1/MIB/OSI on the second cell if it is configured as such. Alternatively, the UE receives SIB1 and MIB of the second cell also on the first cell.

In another particular embodiment, the UE may attempt to access the second network node associated with the second cell. In response to the attempted access, the second network node then starts transmitting SIB1, and the first network node stops if it was transmitting. Thereafter, the UE receives SIB1 from the second network node. Alternatively, the UE receives SIB1 from the first network node.

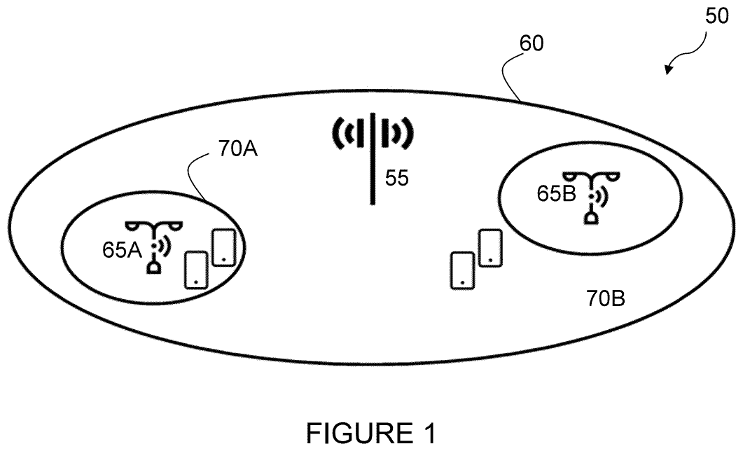

FIG. 1 illustrates an exemplary heterogenous network deployment 50 that includes a coverage-providing network node 55 (e.g., gNB) associated with a first cell 60 that overlaps two capacity-providing network nodes 65A and 65B and their corresponding cells 70A and 70B, according to certain embodiments. Herein, the coverage gNB may also be referred to as a first network node or gNB1. Each capacity node may be referred to as second network nodes, which are associated with second cells. The deployment in FIG. 1 includes multiple capacity-providing network nodes 65A-B. Thus, for certain examples described below, the terms gNB2 and gNB3 are used to distinguish between the multiple second (capacity-providing) network nodes.

According to certain embodiments, rather than providing constant provision of the SSB/MIB/SIB1/OSI in all the cells, one or more of the second network nodes 65A-B omit such transmission and enjoy from energy saving schemes as a result of less frequent transmissions. Instead, the first network node 55 or another second network node provides the corresponding information on behalf of the one or more second network nodes 65A-B.

For example, the first network node 55 may be awake and serving UEs anyway and, thus, the extra transmissions of one or more of SSB/MIB/SIB1/OSI for the sake of second network nodes 65A-B may not be that costly. In a particular embodiment, for example, a second network node such as gNB3 65B of FIG. 1 may be operating at low/zero load. As such, being awake just for the sake of periodic SSB/MIB/SIB1/OSI transmission is not efficient.

Another example of why it may be more efficient for the first network node 55 to transmit the second network node's information may have to do with the number of beams and the sweeping pattern used for transmissions. For example, the first network node 55 may be omni-directional and broadcasting through a single beam whereas the second network node 65A-B may be a multi-beam node. As such, the second network node 65A-B will have to transmit the broadcast data in multiple time instances corresponding to the number of beams whereas the first network node 55 only needs to transmit same data in one single time instance. Alternately, the first network node 55 may be multi-beam but only choose to provide the information relevant to the second network node 65A-B in the beam(s) that overlap the second network node 65A-B.

In 3GPP, there are mechanisms for the second network node 65A-B to provide OSI on-demand. See, 3GPP TS 38.331. However, when it comes to MIB/SIB1, the UEs rely on the fact that these are always provided. Therefore, according to certain embodiments, the UE may ask the second network node 65A-B to provide one or more of SSB/MIB/SIB1 if not transmitted. For example, the UE may know, based on configuration from the first network node 55, that the UE is allowed to ask the first or second network node (depending on the configuration for which node to request from) for one or more of SSB/MIB/SIB1 transmissions.

In a particular embodiment, the configuration may include information for how (through which resources) and when/where the UE may ask for such provision. For example, in a particular embodiment, a dedicated set of preambles may be reserved for such a request in the first or second cell. When it comes to when and where (i.e., position), the first network node 55 may provide a configuration that enables the UE to only transmit such request if the UE detects a specific reference signal (e.g., an SSB, SSB-alike, or any other type of reference signal), potentially with a specific quality (e.g., above a certain threshold), from the second network node 65A-B. Alternately, the UE may have been configured to transmit such a request when in coverage of a certain beam of the first cell (e.g., when in an SSB of the first network node 55 that overlaps the second network node 65A-B), potentially with a certain quality threshold. The timing for when the UE is allowed to transmit such request may be tied to a certain reference point or reference signal of the first or second network node. Example of such references are, System Frame Number (SFN) of the first cell 60 or second cell 70A-B, or in relation to timing of an SSB, or SSB-alike, a discovery signal or any other reference signal.

In some particular embodiments, a second capacity-providing network node such as, for example, the capacity-providing gNB3 65B in FIG. 1, operates with a longer SSB periodicity (such as 160 ms, for example) than a first network node 55 (e.g., coverage-providing gNB1 in in FIG. 1). The UE may then receive information about when and where to find the sparse SSB transmissions of gNB3 65B from gNB1 55. This further allows for defining SSB transmission periods for capacity-providing nodes extending beyond 160 ms, such as 320 ms or 640 ms. The periodicity of the PRACH opportunity windows of the gNB3 65B may be much shorter than the SSB transmission periodicity, enabling the UE to directly access gNB3 65B with low delay.

In particular embodiments, and in the context of FIG. 1, the transmission of SSB from the cell 70B associated with gNB3 65B or another second network node is activated or deactivated by the network. For example, when the SSB transmissions from the cell 70B associated with gNB3 65B is enabled or activated (through information received by the first network node 55), the UE is able to directly access gNB3 65B. Conversely, when the SSB transmissions from gNB3 65B is deactivated by the network, gNB3 65B becomes temporarily invisible to the UE, and the UE must then instead fall back to accessing to or camping on the first network node 55. Thus, the fact that the first network node 55 provides the UE with information related to gNB3 65B (e.g., SSB information, MIB content, SIB1, etc.) does not imply that any such signals are always transmitted from gNB3 65B. By providing the UE with information related to gNB3 65B that is currently invisible to the UE, the activation of gNB3 65B can be made much faster. As soon as the UE detects an SSB transmission from gNB3 65B, for example, the UE immediately knows how to access the corresponding cell.

In a particular embodiment, the UE may be configured with timers and/or counters for determining when and how many times the UE may make such on-demand request(s). For example, the UE may have been configured with a prohibit timer such that it may not request again after the first request until a time period associated with the prohibit timer (which was started upon the first request) has elapsed.

In a particular embodiment, one or more of the SSB/MIB/SIB1/OSI of the capacity-providing network node(s) 65A-B may be provided by the first network node (gNBT) 55. However, in order to not have a constant extra load on the first network node 55, especially if the first network node 55 is covering multiple second network nodes 65A-B (i.e., multiple capacity-providing network nodes) and providing said information for the multiple second network nodes 65A-B, the first network node 55 does not constantly provide said information. Instead, in a particular embodiment, the first network node 55 may advertise (e.g., through its broadcast system information) that, in case there is an interest in one or more of SSB/MIB/SIB1/OSI for one or more of the specific second network nodes 65A-B, a UE may ask for provision of said information. The UE may then ask for one or more of the said information through configured resources and according to timing configuration, and according to position (exemplified above with the reference signal detection) configuration. The resources and/or timing configuration may in one embodiment be different for the different second network nodes 65A-B. For example, the first network node 55 may have configured different set(s) of preambles for different capacity-providing nodes 65A-B. A set of preambles may be provided per capacity-providing node as there may be several preambles for requesting SSB/MIB/SIB1/OSI individually for the different capacity-providing nodes 65A-B.

In all example embodiments above, there may be a mixture of provision schemes with regards to which of the SSB/MIB/SIB1/OSI is transmitted from the first network node 55 or a second network node 65A-B. For example, the first network node 55 may provide SSB/MIB/SIB1 for the second network node 65A-B, but the second network node 65A-B transmits all OSI itself. Another example is that the first network node 55 provides SIB1 and a subset of OSI of the second network node 65A-B, but the second network node 65A-B transmits its own SSB/MIB and another subset of OSI.

In another particular embodiment, the first network node 55 provides the information for the second network node 65A-B temporarily until the second network node 65A-B itself starts transmitting the information. The second network node 65A-B may then inform the first network node 55 through NW internal interfaces (e.g., Xn) that it is taking over the transmission. UEs are informed about the provision through for example, broadcast configuration in first and/or second network nodes 65A-B. In a related embodiment, the network nodes may exchange information and negotiate or command each other to take over the provision. For example, the first network node 55 may be in an overload situation and want to offload itself from provision of second network node's information and, therefore, command the second network node 65A-B to take over the provision of one or more of SSB/MIB/SIB1/OSI itself.

In a particular embodiment, the first network node 55 only provides the information for the second network node 65A-B in certain area of the coverage (e.g., beams/sector/ . . . ). For example, referring to FIG. 1, it may not make sense for gNB1 55 to provide information on behalf of gNB3 65B throughout the whole coverage area of gNB1 55. It may only make sense to provide such information in the parts that overlap gNB3 65B.

In a particular embodiment, the second network node 65A-B provides its own information (e.g., SIB1) only in certain beam where the UE requested the information or based on information provided from the first network node 55 (e.g., first node via NW internal interfaces informs the second network node in which SSBs to provide said information).

### Ways of Providing Signals and Information Related to a Second Cell

In a particular embodiment, the first network node 55 associated with the first cell 60 may transmit signals related to a second cell 70A-B in native mode. For example, the first network node 55 associated with the first cell 60 may transmit SSB (incl. MIB), RMSI/SIB1, and/or OSI, in legacy formats and configurations. The signals may, thus, be consistent with Release 15, Release 16, and Release 17 specifications. With respect to location and content, the signal may be equal or similar to signals transmitted from the second cell 70A-B during its full operation. However, the signals are transmitted from the location of the first network node 55 (gNB1 in FIG. 1, for example).

In another particular embodiment, first network node 55 associated with the first cell 60 may transmit second cell-related signals in legacy signaling-like structures but in modified locations or in modified formats such as, for example, the second cell's signals may be combined with first cell's own information transmission.

In yet another particular embodiment, such as, for example, when second cell-related SSB is not transmitted from the first network node 55, other SI information (e.g., MIB, RMSI/SIB1, OSI, etc.) may be provided not in its legacy format but as an add-on to SI in the first cell. The UE may then read the SI of the first cell and retrieve the second cell-related information from a predetermined SIB (e.g., SIB1 or another SIB or an energy-savings or newly defined SIB).

### Spatial and Synchronization Consistency Aspects of Information Provision for Second Cells

In a particular embodiment, to reduce the additional signaling load on the first network node 55, the first network node 55 may provide SSB and/or other information related to a second cell 70A-B only in a part of the second cell's coverage area. For example, in the context of FIG. 1, the coverage-providing gNBT 55 may provide information relating to the capacity-providing gNB2 65A only in the left-hand half of the gNB1 coverage area and information relating to capacity-providing gNB3 65B only in the right-hand half of the gNBT coverage area.

In a particular embodiment, for example, if the first network node 55 provides SSB transmissions related to the second cell, the second-cell SSBs and other information may be transmitted only in directions coinciding with the second cell coverage area. In other directions, as seen from the first cell gNB/TRP, second-cell SSB transmission is omitted.

In a particular embodiment, such as, for example, when the first network node 55 provides SI related to a second cell in its SIB, the spatial selectivity may be achieved, for example, by providing different MIB or SIB information in different first cell SSBs. In a particular embodiment, for example, SSBs transmitted in the direction of the second cell coverage area specify a SIB transmission (e.g., a CSS/common CORESET configuration), containing additional second-cell-related SI, whereas other SSB directions specify SIB transmissions not containing information related to the second-cell.

In a particular embodiment, the first network node 55 may transmit an SSB related to a second cell that a UE may use to perform the Random Access procedure with regard to the second cell. According to previous techniques, the received SSB timing is used by the UE to align its uplink (UL) PRACH preamble transmission. According to certain embodiments described herein, however, the second network node 65A-B may extend its PRACH reception window by, for example, not scheduling other UL transmissions shortly before or after the PRACH window to allow for timing misalignment due to UE-gNBT and UE-gNB2 distance differences, where the omitted region length may depend on the maximum expected distance difference.

In a particular embodiment, and in the context of FIG. 1, the gNB1 55 may indicate in its second-cell SI provision whether legacy QCL rules apply for second-cell transmissions. If the gNB1 55 and gNB2 65A are physically co-located and, for example, the gNB2 65A provides capacity cell coverage in a subset of gNB1 coverage area, the UE may use second-cell transmitted by gNB1 as a direction indicator for reciprocal PRACH preamble transmission. If the gNB1 and gNB2 are not physically co-located, the gNB1 may signal that the reciprocity should not be assumed (received SSB direction should not be used for PRACH preamble direction), but that, for example, the PRACH preamble transmission should be swept over an omni-directional area.

In a particular embodiment, and in the context of FIG. 1, when the first network node 55 is providing SSB for a second cell and the gNB1 55 and gNB2 65A are not co-located, the NW configuration may indicate that frequency synchronization obtained from the first cell is valid for the second cell for UEs whose vehicular speed is below a threshold, where the threshold may depend on the frequency band, the second cell numerology, or the FR. The UE may estimate its vehicular speed based on, for example, Doppler spread or frequency offsets with regard to multiple cells such as, for example, the first cell and additional cells.

### Example UE Implementation Scenario/Method

According to certain embodiments, a method in a UE where the UE receives a configuration of at least two cells and where at least on one cell, namely the second cell 70A-B, the UE is not configured to receive at least one of the periodic SSB or SIB1 or MIB or other SI. The UE may additionally be configured such that from another cell, namely the first cell 60, receive the corresponding SIB1 or MIB or other SI related to the second cell 70A-B.

Optionally, in a particular embodiment, if the UE is not configured to receive periodic SSB on the second cell 70A, it also means that it is not going to receive SIB1 or other SIBs/SI.

Optionally, in a particular embodiment, the UE is only configured to receive a “light” SSB-alike signal (e.g., without parts of the MIB or a full MIB) on the second cell 70A. In this case, the partial MIB or full MIB is transmitted on the first cell 60, if the intention is to transmit a MIB for this cell. In a similar way, SIB1 or other SI/SIBs may be transmitted on the first cell 60.

Optionally, in a particular embodiment, the UE is configured to receive SSB on the second cell 70A, but is not configured to receive SIB1 or other SI on the second cell, and SIB1/other SI, if configured for the second cell 70A, is transmitted on the first cell 60.

Optionally, in a particular embodiment, the UE is allowed to camp on the second cell 70A despite that it is not providing the SSB/minimum SI and other essential system information. The UE knows that the corresponding information may be retrieved from a first network node 55 based on one or more of
i. specific characteristics of a reference signal in the second cell 70A (e.g., specific type of SSB such as a light-weight SSB,
ii. an indicator in the MIB part of the SSB,
iii. a light weight MIB with the minimum information required transmitted along the light weight SSB, and
iv. a SIB transmitted over the first cell 60, e.g., an energy saving SIB.

Optionally, in any of the particular embodiments described above, the UE is additionally configured to be able to ask from the second network node 65A for on-demand SSB, SIB1, or MIB to be transmitted.

Optionally, in a particular embodiment, the UE is configured to be able to ask from a first network node 55 for one or more of on-demand SSB, SIB1, MIB or other SIBs to be transmitted.

Optionally, in a further particular embodiment, the first network node 55 provides one or more of the information (SSB/MIB/SIB1/OSI) itself on behalf of the second network node 65A. In one example, the UE transmits the demand to the second node 65A over the resources which are pre-configured for the UE, or that the UE has received the configuration, e.g., through higher layer signaling or L1/L2 signaling from the first network node 55.

Optionally, in another further particular embodiment, the first network node 55 asks the second network node 65A to provide one or more of the information (SSB/MIB/SIB1/OSI).

Optionally, in another further particular embodiment, in response to the UE demand, the second network node 65A starts transmitting SIB1/MIB/OSI on the second cell 70A and the first network node 55 stops its transmission (based on NW inter-cell communication), if it was transmitting them, and the UE receives SIB1/MIB/OSI on the second cell if it is configured as such. Alternatively, the UE receives SIB1 and MIB of the second cell also on the first cell.

Optionally, in a particular embodiment, the UE may have attempted to access the second node 65A, and in response to the attempted access, the second node 65A starts transmitting SIB1, and the first node 55 stops if it was transmitting, and the UE receives SIB1 from the second node 65A. Alternatively, the UE receives SIB1 from the first node 55.

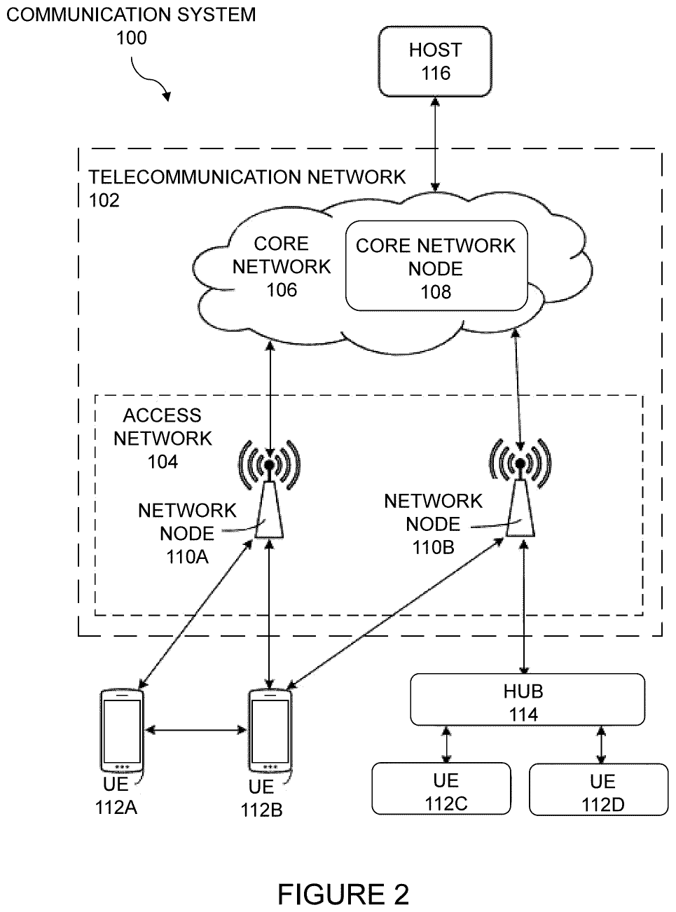

FIG. 2 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

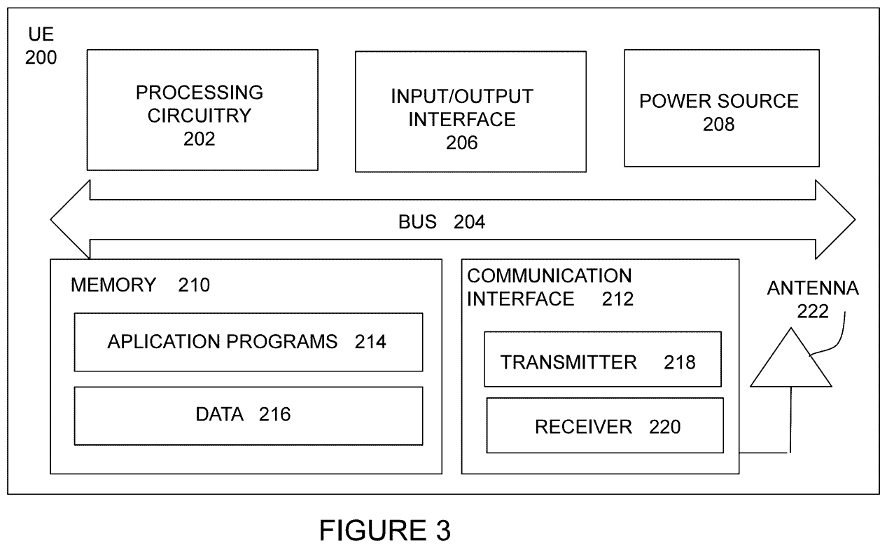

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

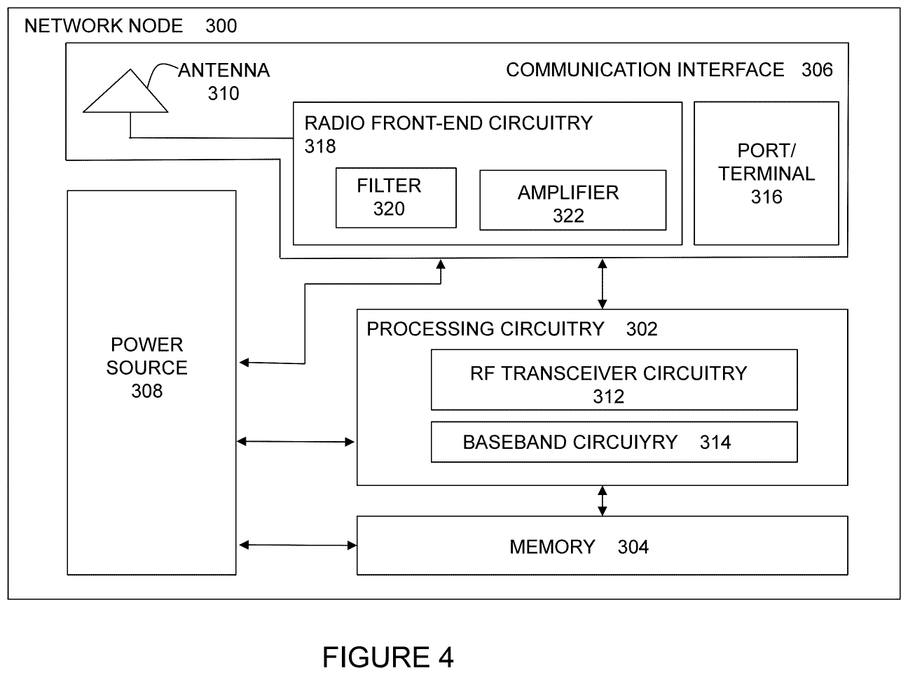

FIG. 4 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

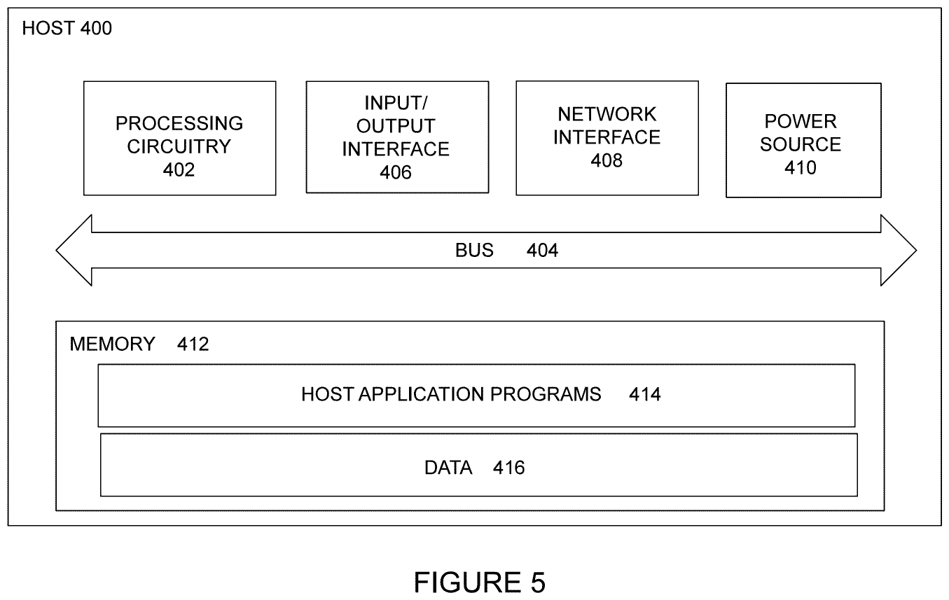

FIG. 5 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

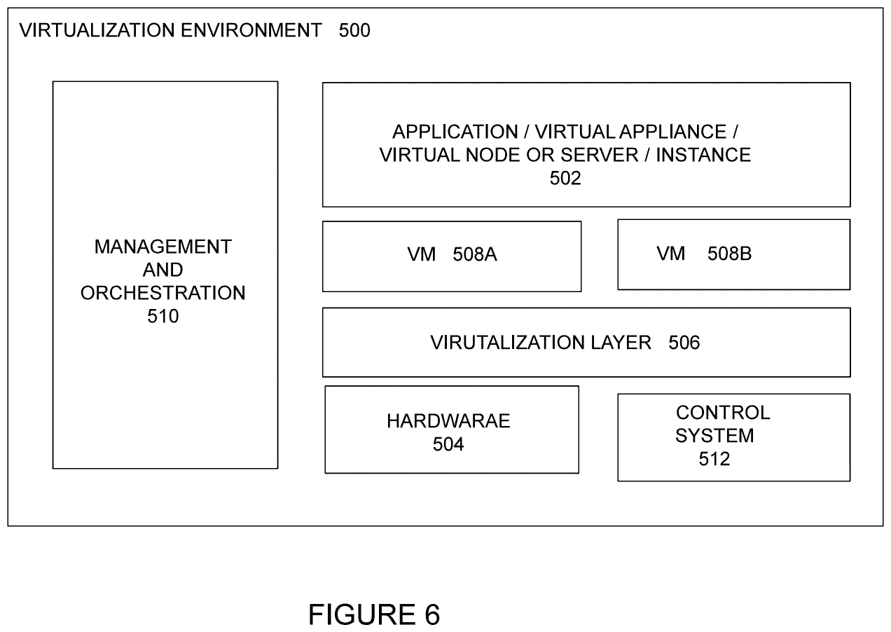

FIG. 6 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

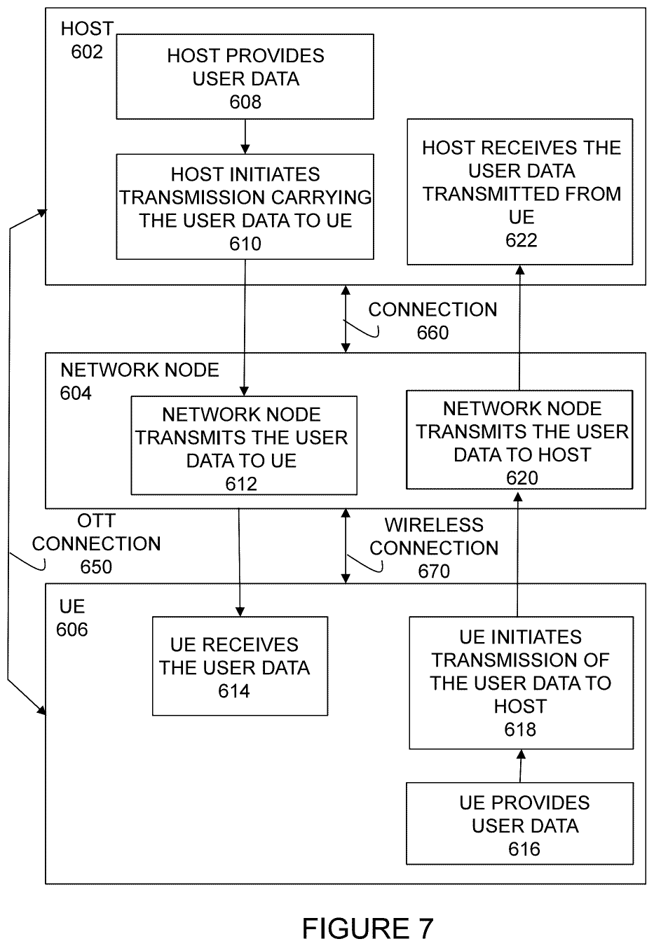

FIG. 7 shows a communication diagram of a host 602 communicating via a network node 604 with a UE 606 over a partially wireless connection in accordance with some embodiments.

Example implementations, in accordance with various embodiments, of the UE (such as a UE 112a of FIG. 2 and/or UE 200 of FIG. 3), network node (such as network node 110a of FIG. 2 and/or network node 300 of FIG. 4), and host (such as host 116 of FIG. 2 and/or host 400 of FIG. 5) discussed in the preceding paragraphs will now be described with reference to FIG. 7.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

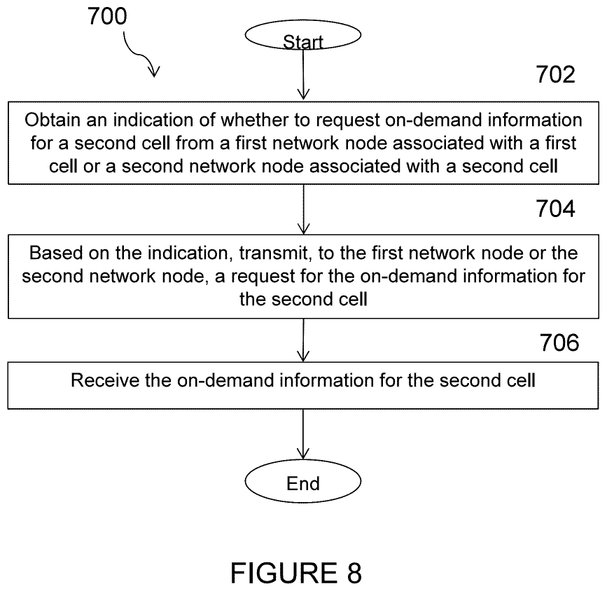

FIG. 8 illustrates a method 700 by a UE 112 for receiving on-demand information, according to certain embodiments. The UE 112 is served by a first network node 55 associated with a first cell 60. At step 702, the UE 112 obtaining an indication of whether to request on-demand information for a second cell 70A from a first network node 55 associated with a first cell 60 or a second network node 65A associated with the second cell 70A. Based on the indication, the UE 112 transmits, to the first network node 55 or the second network node 65A, a request for the on-demand information for the second cell 70A, at step 704. At step 706, the UE 112 receives the on-demand information for the second cell.

In a particular embodiment, obtaining the indication of whether to request the on-demand information from the first network node or the second network node comprises at least one of: obtaining the indication from configuration information; receiving a MIB from the second cell; receiving a SIB transmitted from the first cell.

In a particular embodiment, obtaining the indication of whether to request the on-demand information from the first network node or the second network node comprises at least one of: identifying a characteristic of a reference signal received from the second cell; receiving an indicator in a portion of a Synchronization Signal Block, SSB, received from the second cell; receiving the SSB from the second cell; receiving a broadcast message from the first network node; detecting at least one reference signal from the second network node; detecting at least one reference signal from the second network node that is associated with a quality level that is above a first threshold; detecting at least one beam of the first cell that overlaps with the second cell; detecting at least one beam of the first cell that overlaps with the second cell and is associated with a quality level that is above a second threshold; and determining that a timer has expired, wherein the timer measures a time period since a previous request for SI for the second cell.

In a particular embodiment, the request is transmitted using at least one resource that is preconfigured for the UE. Alternatively, the request is transmitted using at least one allocated resource that has been received from the first network node, or the request is transmitted using at least one resource that has been received via higher layer signaling or L1/L2 signaling from the first network node.

In a particular embodiment, obtaining the indication comprises determining, based on at least one SSB configuration, SMTC, and broadcast configuration of the first cell and/or the second cell that: the UE is configured to receive at least one of: periodic SSB; SIB1; MIB; or OSI for the first cell, and the UE is not configured to receive at least one of periodic SSB, SIB1, MIB, or OSI for the second cell.

In a particular embodiment, the request for the on-demand information is transmitted to the first network node associated with the first cell, and the on-demand information is received from the second network node associated with the second cell.

In a particular embodiment, the on-demand information comprises at least one of: a SSB, a MIB, a SIB1, a SIB2, a SIB3, and OSI.

In a particular embodiment, the on-demand information is received via at least one beam indicated in the request or by the first network node.

In a particular embodiment, the request for the on-demand information is transmitted to the first network node associated with the first cell or the second network node associated with the second cell, and the on-demand information is received from the first network node.

In a particular embodiment, the on-demand information comprises a partial or full MIB for the second cell.

In a further particular embodiment, the on-demand information received from the first network node comprises at least one of: a SIB1, a SIB2, a SIB3, and OSI. The method includes UE 112 receiving a signal from the second network node associated with the second cell, and the signal includes a SSB for the second cell.

In a further particular embodiment, the on-demand information received from the first network node comprises at least one of: SSB, MIB, and SIB1. The method further includes the UE 112 receiving a signal from the second network associated with the second cell, and the signal from the second network node comprising Other System Information, OSI, for the second cell.

In a further particular embodiment, the on-demand information received from the first network node includes a SIB1 for the second cell, and the method further includes the UE 112 receiving a signal from the second network associated with the second cell. The signal from the second network node includes SSB and a MIB for the second cell.

In a further particular embodiment, the on-demand information received from the first network node includes a first portion of OSI for the second cell, and the UE 112 receives a signal from the second network associated with the second cell that includes a second portion of OSI for the second cell.

In a particular embodiment, prior to receiving the on-demand information for the second cell, the UE 112 camps on the second cell.

In a particular embodiment, the UE 112 attempts to access the second cell, and the on-demand information is received in response to attempting to access the second cell.

In a particular embodiment, the first network node associated with the first cell is a coverage-providing network node, and the second network node associated with the second cell is a capacity-providing network node.

In a particular embodiment, the first network node is in an active or awake state, and the first network node is serving the UE.

In a particular embodiment, the first network node is configured to transmit a single omni-directional beam, and the second network node associated with the second cell is configured to transmit multiple beams.

In a particular embodiment, the first network node is configured to operate at a first SSB periodicity, the second network node associated with the second cell is configured to operate at a second SSB periodicity, and the second SSB periodicity is longer than the first SSB periodicity.

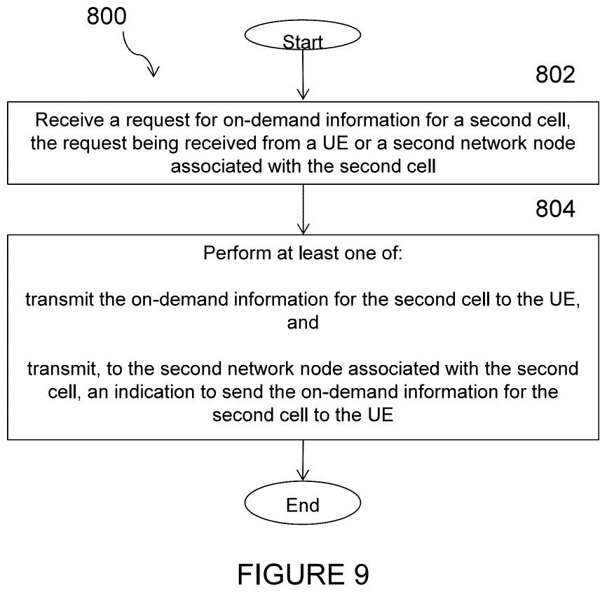

FIG. 9 illustrates a method 800 for transmitting on-demand information by a first network node 55 associated with a first cell 60, according to certain embodiments. The method begins at step 802 when the first network node 55 receives a request for on-demand information for a second cell 70A. The request is received from a UE 112 or a second network node 65A associated with the second cell. At step 804, the first network node 55 performing at least one of: transmitting the on-demand information for the second cell 70A to the UE 112, and/or transmitting, to the second network node 65A associated with the second cell 70A, an indication to send the on-demand information for the second cell 70A to the UE 112.

In a particular embodiment, the first network node 55 transmits, to the UE, an indication of whether the UE is to request the on-demand information from the first network node or the second network node.

In a particular embodiment, 23. The method of Claim 22, wherein the indication is transmitted to the UE via at least one of: a SIB, a broadcast message, and a beam of the first cell that overlaps with the second cell.

In a particular embodiment, the indication is transmitted to the UE via at least one SSB configuration, SMTC, and broadcast configuration and indicates that: the UE is configured to receive at least one of periodic SSB, SIB1, MIB, or OSI for the first cell, and the UE is not configured to receive at least one of periodic SSB, SIB1, MIB, or OSI for the second cell.

In a particular embodiment, the request is received from the UE in at least one resource that is preconfigured for the UE.

In a particular embodiment, the first network node 55 transmits, to the UE, an indication of at least one allocated resource, and wherein the request is received from the UE in the at least one allocated resource.

In a particular embodiment, the first network node 55 transmits, to the UE, higher layer signaling or L1/L2 signaling that indicates at least one resource, and the request is received from the UE in the at least one resource.

In a particular embodiment, the request for the on-demand information is received from the UE, and the first network node transmits the indication to the second network node based on receiving the request from the UE.

In a particular embodiment, the on-demand information is transmitted by the second network node to the UE via at least one beam that is indicated in the request from the UE or in the indication to the second network node from the first network node.

In a particular embodiment, the request for the on-demand information is received from the UE, and the first network node transmits the on-demand information to the UE based on receiving the request from the UE.

In a further particular embodiment, the on-demand information transmitted to the UE includes a partial or full MIB for the second cell.

In a particular embodiment, the on-demand information transmitted to the UE comprises at least one of a SIB1, a SIB2, a SIB3, and OSI.

In a particular embodiment, the on-demand information transmitted to the UE comprises at least one of: a SSB, a MIB, and a SIB1. The second network node associated with the second cell is configured to transmit OSI for the second cell.

In a particular embodiment, the on-demand information transmitted to the UE includes SIB-1 for the second cell, and the second network node associated with the second cell is configured to transmit SSB and MIB for the second cell.

In a particular embodiment, the on-demand information transmitted to the UE includes a first portion of OSI for the second cell, and the second network node associated with the second cell is configured to transmit a second portion of OSI for the second cell.

In a particular embodiment, the first network node 55 determines to cease transmitting the on-demand information to the UE.

In a further particular embodiment, the determining to cease transmitting the on-demand information to the UE is based on or in response to receiving an indication from the second network node associated with the second cell that the second network node is transmitting the on-demand information.

In a further particular embodiment, the first network node 55 transmits, to the second network node associated with the second cell, an indication that the second network node is to initiate transmitting the on-demand information to the UE. The determining to cease transmitting the on-demand information to the UE is based on or in response to transmitting the indication to the second network node.

In a particular embodiment, the first network node associated with the first cell is a coverage-providing network node, and the second network node associated with the second cell is a capacity-providing network node.

In a particular embodiment, the first network node is in an active or awake state, and the first network node is serving the UE.

In a particular embodiment, the first network node is configured to transmit a single omni-directional beam, and the second network node associated with the second cell is configured to transmit multiple beams.

In a particular embodiment, the first network node is configured to operate at a first SSB periodicity, the second network node associated with the second cell is configured to operate at a second SSB periodicity, and the second SSB periodicity is longer than the first SSB periodicity.

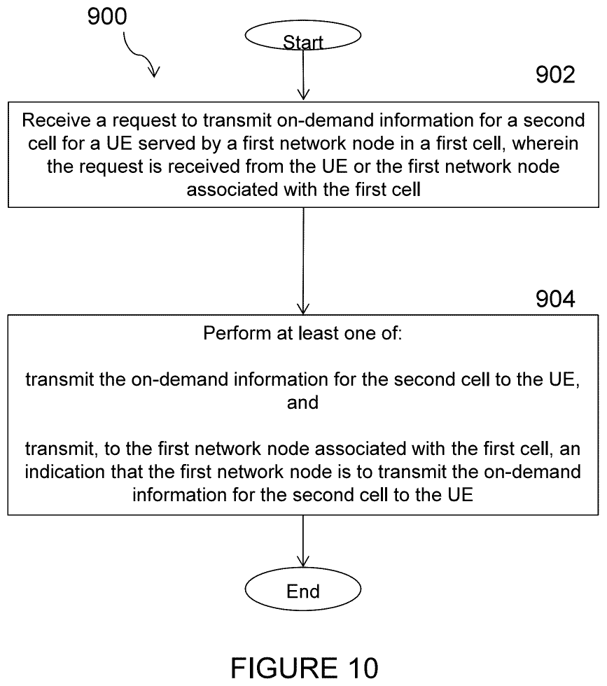

FIG. 10 illustrates a method 900 for transmitting on-demand information by a second network node 65A associated with a second cell 70A, according to certain embodiments. The method begins at step 902 when the second network node 65A receives a request to transmit on-demand information for the second cell 70A for a UE 112 served by a first network node 55 in a first cell 60. The request is received from the UE 112 or the first network node 55 associated with the first cell 60. At step 904, the second network node 65A performs at least one of: transmitting the on-demand information for the second cell 70A to the UE 112, and/or transmitting, to the first network node 55 associated with the first cell 60, an indication that the first network node 55 is transmit the on-demand information for the second cell 70A.

In a particular embodiment, the second network node 65A transmits, to the UE, an indication of whether the UE is to request the on-demand information from the first network node or the second network node.

In a particular embodiment, the indication is transmitted to the UE via at least one of: a MIB transmitted from the second cell; a reference signal transmitted from the second cell; a reference signal from the second cell that is associated with a quality level that is above a first threshold; a SSB transmitted from the second cell; and a beam of the first cell that overlaps with the second cell.

In a particular embodiment, the request is received from the first network node, and the on-demand information is transmitted to the UE.

In a particular embodiment, the on-demand information is transmitted to the UE via at least one beam that is indicated in the request from the UE or in an indication from the first network node.

In a particular embodiment, the on-demand information comprises at least one of a SSB, a MIB, a SIB1, a SIB2, a SIB3, and OSI.

In a particular embodiment, the request is received from the UE, and the indication is transmitted to the first network node.

In a particular embodiment, the request is received from the first network node and the indication is transmitted to the first network node.

In a particular embodiment, the indication indicates that the first network node is to transmit at least one of a SIB1, a SIB2, a SIB3, and OSI. The method includes the second network node transmitting a signal to the UE, and the signal comprises a SSB for the second cell.

In a particular embodiment, the indication indicates that the first network node is to transmit at least one of: a SSB, a MIB, and a SIB1, and the second network node transmits a signal to the UE, and the signal includes OSI for the second cell.

In a particular embodiment, the indication indicates that the first network node is to transmit a SIB1 for the second cell, and the second network node transmits a signal to the UE. The signal comprising a SSB and a MIB for the second cell.

In a particular embodiment, the indication indicates that the first network node is to transmit a first portion of OSI for the second cell, and the second network node transmits a signal to the UE, the signal comprising a second portion of OSI for the second cell.

In a particular embodiment, the UE is camping on the second cell before the on-demand information for the second cell is transmitted.

In a particular embodiment, the second network node receives, from the UE, a request to access the second cell, and the on-demand information is transmitted in response to the request to access the second cell.

In a particular embodiment, the second network node transmits, to the first network node, an indication that the second network node is transmitting the on-demand information to the UE.

In a particular embodiment, the first network node associated with the first cell is a coverage-providing network node, and the second network node associated with the second cell is a capacity-providing network node.

In a particular embodiment, the first network node is in an active or awake state.

In a particular embodiment, the first network node is configured to transmit a single omni-directional beam, and the second network node associated with the second cell is configured to transmit multiple beams.

In a particular embodiment, the first network node is configured to operate at a first SSB periodicity, the second network node associated with the second cell is configured to operate at a second SSB, and the second SSB periodicity is longer than the first SSB periodicity.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for receiving on-demand information associated with a synchronization signal block, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for transmitting on-demand information associated with a synchronization signal block, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for receiving on-demand information, the UE served by a first network node associated with a first cell, the method comprising: receiving, from the first network node associated with the first cell, system information for a second cell.

Example Embodiment C2. The method of Example Embodiment C1, wherein: the UE is configured to receive at least one of periodic SSB, SIB1, MIB, or OSI for the first cell, and the UE is not configured to receive at least one of periodic SSB, SIB1, MIB, or OSI for the second cell.

Example Embodiment C3. The method of any one of Example Embodiments C1 to C2, comprising receiving at least one configuration of the first cell and the second cell, wherein the at least one configuration indicates that: the UE is configured to receive at least one of periodic SSB, SIB1, MIB, or OSI for the first cell, and the UE is not configured to receive at least one of periodic SSB, SIB1, MIB, or OSI for the second cell.

Example Embodiment C4. The method of any one of Example Embodiments C1 to C3, comprising receiving a signal from a second network node associated with the second cell, and wherein the signal does not include a full MIB.

Example Embodiment C5. The method of any one of Example Embodiments C1 to C4, wherein the system information received from the first network node includes a partial or full MIB for the second cell.

Example Embodiment C6. The method of any one of Example Embodiments C1 to C5, comprising receiving a signal from a second network node associated with the second cell, and wherein the signal comprises a SSB for the second cell but does not include at least one of SIB1 and OSI for the second cell.

Example Embodiment C7. The method of any one of Example Embodiments C1 to C6, wherein the system information received from the first network node includes at least one of SIB1, SIB2, SIB3, and OSI for the second cell.

Example Embodiment C8. The method of any one of Example Embodiments C1 to C7, wherein the system information received from the first network node includes at least one of SSB, MIB, and SIB1 for the second cell, and the method further comprises receiving a signal from a second network associated with the second cell, and wherein the signal from the second network node comprises OSI for the second cell.

Example Embodiment C9. The method of any one of Example Embodiments C1 to C7, wherein the system information received from the first network node includes at least one of SSB, MIB, and SIB1 for the second cell, and the method further comprises receiving a signal from a second network associated with the second cell, and wherein the signal from the second network node comprises OSI for the second cell.

Example Embodiment C10. The method of any one of Example Embodiments C1 to C7, wherein the system information received from the first network node includes SIB1 for the second cell, and the method further comprises receiving a signal from a second network associated with the second cell, and wherein the signal from the second network node comprises SSB and MIB for the second cell.

Example Embodiment C11. The method of any one of Example Embodiments C1 to C7, wherein the system information received from the first network node includes a first portion of OSI for the second cell, and the method further comprises receiving a signal from a second network associated with the second cell, and wherein the signal from the second network node comprises a second portion of OSI for the second cell.

Example Embodiment C12. The method of any one of Example Embodiments C1 to C11, wherein prior to receiving the system information for the second cell from the first network node, the method comprises camping on the second cell.

Example Embodiment C13. The method of any one of Example Embodiments C1 to C12, wherein prior to receiving the system information for the second cell from the first network node, the method comprises transmitting, to the first network node, a request for the system information for the second cell.

Example Embodiment C14. The method of Example Embodiment C13, wherein the request is transmitted using at least one resource that is preconfigured for the UE.

Example Embodiment C15. The method of Example Embodiment C13, wherein the request is transmitted using at least one resource that has been received via a configuration from the first network node.

Example Embodiment C16. The method of Example Embodiment C13, wherein the request is transmitted using at least one resource that has been received via higher layer signaling or L1/L2 signaling from the first network node.

Example Embodiment C17. The method of any one of Example Embodiments C1 to C16, comprising determining to request the system information from the first network node based on at least one of: a characteristic of a reference signal received in/from the second cell; an indicator in a portion of a SSB received in/from the second cell; a light weight MIB received from the second cell; a lightweight SSB received from the second cell; and a SIB transmitted from the first cell.

Example Embodiment C18. The method of any one of Example Embodiments C1 to C17, comprising transmitting, to a second network node associated with the second cell, a request for the system information or additional system information.

Example Embodiment C19. The method of any one of Example Embodiments C1 to C18, comprising receiving, from the second network node associated with the second cell, the system information or additional system information.

Example Embodiment C20. The method of Example Embodiment C19, wherein the system information or additional system information received from the second network node comprises at least one of a SSB, MIB, SIB1, and OSI.

Example Embodiment C21. The method of any one of Example Embodiments C19 to C20, comprising attempting to access the second cell, and wherein the system information or additional system information is received from the second network node in response to attempting to access the second cell.

Example Embodiment C22. The method of any one of Example Embodiments C1 to C21, wherein the first network node associated with the first cell comprises a coverage-providing network node, and wherein the second network node associated with the second cell comprises a capacity-providing network node.

Example Embodiment C23. The method of Example Embodiment C22, wherein the first cell overlaps at least a portion of the second cell.

Example Embodiment C24. The method of any one of Example Embodiments C1 to C23, wherein the first network node is in an active or awake state and the first network node is serving the UE.

Example Embodiment C25. The method of any one of Example Embodiments C1 to C24, wherein a second network node associated with the second cell is operating at a low or zero load.

Example Embodiment C26. The method of any one of Example Embodiments C1 to C25, wherein the first network node is configured to transmit a single omni-directional beam, and wherein a second network node associated with the second cell is configured to transmit multiple beams.

Example Embodiment C27. The method of any one of Example Embodiments C1 to C26, wherein the first network node is configured to operate at a first SSB periodicity, and wherein a second network node associated with the second cell is configured to operate at a second SSB periodicity, and wherein the second SSB periodicity is longer than the first SSB periodicity.

Example Embodiment C28. The method of any one of Example Embodiments C1 to C27, wherein the first network node comprises a gNB.

Example Embodiment C29. The method of Example Embodiments C1 to C28, further comprising: providing user data; and forwarding the user data to a host via the transmission to the network node.

Example Embodiment C30. A user equipment comprising processing circuitry configured to perform any of the methods of Example Embodiments C1 to C29.

Example Embodiment C31. A wireless device comprising processing circuitry configured to perform any of the methods of Example Embodiments C1 to C29.

Example Embodiment C32. A computer program comprising instructions which when executed on a computer perform any of the methods of Example Embodiments C1 to C29.

Example Embodiment C33. A computer program product comprising computer program, the computer program comprising instructions which when executed on a computer perform any of the methods of Example Embodiments C1 to C29.

Example Embodiment C34. A non-transitory computer readable medium storing instructions which when executed by a computer perform any of the methods of Example Embodiments C1 to C29.

### Group D Example Embodiments

Example Embodiment D1. A method for transmitting on-demand information by a first network node associated with a first cell, the method comprising: transmitting, to a User Equipment (UE), system information for a second cell.

Example Embodiment D2. The method of Example Embodiment D1, wherein: the UE is configured to receive at least one of periodic SSB, SIB1, MIB, or OSI for the first cell, and the UE is not configured to receive at least one of periodic SSB, SIB1, MIB, or OSI for the second cell.

Example Embodiment D3. The method of any one of Example Embodiments D1 to D2, comprising transmitting at least one configuration to the UE, and wherein the at least one configuration indicates at least one of: the UE is configured to receive at least one of periodic SSB, SIB1, MIB, or OSI for the first cell, and the UE is not configured to receive at least one of periodic SSB, SIB1, MIB, or OSI for the second cell.

Example Embodiment D4. The method of any one of Example Embodiments D1 to D3, wherein the system information transmitted to the UE includes a partial or full MIB for the second cell.

Example Embodiment D5. The method of any one of Example Embodiments D1 to D4, wherein the system information transmitted to the UE includes at least one of SIB1, SIB2, SIB3, and OSI for the second cell.

Example Embodiment D6. The method of any one of Example Embodiments D1 to D5, wherein the system information transmitted to the UE includes at least one of SSB, MIB, and SIB1 for the second cell, and wherein a second network node associated with the second cell is configured to transmit OSI for the second cell.

Example Embodiment D7. The method of any one of Example Embodiments D1 to D5, wherein the system information transmitted to the UE includes at least one of SSB, MIB, and SIB1 for the second cell, and wherein a second network node associated with the second cell is configured to transmit OSI for the second cell.

Example Embodiment D8. The method of any one of Example Embodiments D1 to D5, wherein the system information transmitted to the UE includes SIB1 for the second cell, and wherein a second network node associated with the second cell is configured to transmit SSB and MIB for the second cell.

Example Embodiment D9. The method of any one of Example Embodiments D1 to D8, wherein the system information transmitted to the UE includes a first portion of OSI for the second cell, and wherein a second network node associated with the second cell is configured to transmit a second portion of OSI for the second cell.

Example Embodiment D10. The method of any one of Example Embodiments D1 to D9, wherein the UE camps on the second cell prior to receiving the system information for the second cell from the first network node.

Example Embodiment D11. The method of any one of Example Embodiments D1 to D10, wherein prior to transmitting the system information for the second cell to the UE, the method comprises receiving, from the UE, a request for the system information for the second cell.

Example Embodiment D12. The method of Example Embodiment D11, wherein the request is received in at least one resource that is preconfigured for the UE.

Example Embodiment D13. The method of Example Embodiment D11, comprising transmitting, to the UE, a configuration that includes at least one resource, the request received in the at least one resource.

Example Embodiment D14. The method of Example Embodiment D11, comprising transmitting, to the UE, higher layer signaling or L1/L2 signaling that includes at least one resource, the request received in the at least one resource.

Example Embodiment D15. The method of any one of Example Embodiments D1 to D14, comprising determining to cease transmitting the system information to the UE.

Example Embodiment D16. The method of Example Embodiment D15, wherein the determining to cease transmitting the system information to the UE is based on or in response to receiving an indication from a second network node associated with the second cell that the second network node is transmitting the system information.

Example Embodiment D17. The method of Example Embodiment D16, comprising transmitting, to a second network node associated with the second cell, an indication that the second network node is to transmit the system information or additional system information to the UE, and wherein the determining to cease transmitting the system information to the UE is based on or in response to transmitting the indication to the second network node.

Example Embodiment D18. The method of any one of Example Embodiments D1 to D17, wherein the first network node associated with the first cell comprises a coverage-providing network node, and wherein a second network node associated with the second cell comprises a capacity-providing network node.

Example Embodiment D19. The method of any one of Example Embodiments D1 to D18, wherein the first cell overlaps at least a portion of the second cell.

Example Embodiment D20. The method of any one of Example Embodiments D1 to D19, wherein the first network node is in an active or awake state and the first network node is serving the UE.

Example Embodiment D21. The method of any one of Example Embodiments D1 to D20, wherein a second network node associated with the second cell is operating at a low or zero load.

Example Embodiment D22. The method of any one of Example Embodiments D1 to D21, wherein the first network node is configured to transmit a single omni-directional beam, and wherein a second network node associated with the second cell is configured to transmit multiple beams.

Example Embodiment D23. The method of any one of Example Embodiments D1 to D22, wherein the first network node is configured to operate at a first SSB periodicity, and wherein a second network node associated with the second cell is configured to operate at a second SSB periodicity, and wherein the second SSB periodicity is longer than the first SSB periodicity.

Example Embodiment D24. The method of any one of Example Embodiments D1 to D23, wherein the first network node comprises a gNodeB (gNB).

Example Embodiment D25. The method of any of the previous Example Embodiments, further comprising: obtaining user data; and forwarding the user data to a host or a user equipment.

Example Embodiment D26. A network node comprising processing circuitry configured to perform any of the methods of Example Embodiments D1 to D25.

Example Embodiment D27. A computer program comprising instructions which when executed on a computer perform any of the methods of Example Embodiments D1 to D25.

Example Embodiment D28. A computer program product comprising computer program, the computer program comprising instructions which when executed on a computer perform any of the methods of Example Embodiments D1 to D25.

Example Embodiment D29. A non-transitory computer readable medium storing instructions which when executed by a computer perform any of the methods of Example Embodiments D1 to D25.

### Group E Example Embodiments

Example Embodiment E1. A method for transmitting on-demand information by a second network node associated with a second cell, the method comprising: receiving a request to transmit system information for the second cell to/for a User Equipment (UE), wherein the UE is served by a first network node associated with a first cell; and transmitting the system information for the second cell.

Example Embodiment E2. The method of Example Embodiment E1, wherein: the request is received from the UE; and the system information is transmitted to the UE.

Example Embodiment E3. The method of Example Embodiment E1, wherein: the request is received from the UE; and the system information is transmitted to the first network node.

Example Embodiment E4. The method of Example Embodiment E1, wherein: the request is received from the first network node; and the system information is transmitted to the UE.

Example Embodiment E5. The method of Example Embodiment E1, wherein: the request is received from the first network node; and the system information is transmitted to the first network node.

Example Embodiment E6. The method of any one of Example Embodiments E1 to E5, wherein: the UE is configured to receive at least one of periodic SSB, SIB1, MIB, or OSI for the first cell from a first network node, and the UE is not configured to receive at least one of periodic SSB, SIB1, MIB, or OSI for the second cell from the second network node.

Example Embodiment E7. The method of any one of Example Embodiments E1 to E6, wherein the system information for the second cell comprises at least one of a SSB, MIB, SIB1, and OSI.

Example Embodiment E8. The method of any one of Example Embodiments E1 to E7, wherein the system information for the second cell does not include a full MIB.

Example Embodiment E9. The method of any one of Example Embodiments E1 to E8, wherein the system information for the second cell includes a portion of a MIB.

Example Embodiment E10. The method of any one of Example Embodiments E1 to E9, wherein the system information for the second cell includes a SSB but does not include at least one of SIB1 and OSI for the second cell.

Example Embodiment E11. The method of any one of Example Embodiments E1 to E10, wherein the system information for the second cell includes comprises OSI.

Example Embodiment E12. The method of any one of Example Embodiments E1 to E11, wherein system information for the second cell includes SSB and MIB for the second cell.

Example Embodiment E13. The method of any one of Example Embodiments E1 to E121, wherein the system information for the second cell comprises a portion of OSI.

Example Embodiment E14. The method of any one of Example Embodiments E1 to E13, wherein the UE is camping on the second cell before the system information for the second cell is transmitted.

Example Embodiment E15. The method of any one of Example Embodiments E1 to E14, comprising receiving, from the UE, a request to access the second cell, and wherein the system information or additional system information is transmitted in response to the request to access the second cell.

Example Embodiment E16. The method of any one of Example Embodiments E1 to E15, comprising transmitting, to the first network node, an indication that the second network node is transmitting the system information to the UE.

Example Embodiment E17. The method of any one of Example Embodiments E1 to E16, wherein the first network node associated with the first cell comprises a coverage-providing network node, and wherein the second network node associated with the second cell comprises a capacity-providing network node.

Example Embodiment E18. The method of any one of Example Embodiments E1 to E17, wherein the first cell overlaps at least a portion of the second cell.

Example Embodiment E19. The method of any one of Example Embodiments E1 to E18, wherein the first network node is in an active or awake state and the first network node is serving the UE.

Example Embodiment E20. The method of any one of Example Embodiments E1 to E19, wherein the second network node associated with the second cell is operating at a low or zero load.

Example Embodiment E21. The method of any one of Example Embodiments E1 to E20, wherein the first network node is configured to transmit a single omni-directional beam, and wherein the second network node associated with the second cell is configured to transmit multiple beams.

Example Embodiment E22. The method of any one of Example Embodiments E1 to E21, wherein the first network node is configured to operate at a first SSB periodicity, and wherein the second network node associated with the second cell is configured to operate at a second SSB periodicity, and wherein the second SSB periodicity is longer than the first SSB periodicity.

Example Embodiment E23. The method of any one of Example Embodiments E1 to E22, wherein the second network node comprises a gNB.

Example Embodiment E24. The method of any one of Example Embodiments E1 to E23, further comprising: obtaining user data; and forwarding the user data to a host or a user equipment.

Example Embodiment E25. A network node comprising processing circuitry configured to perform any of the methods of Example Embodiments E1 to E24.

Example Embodiment E26. A computer program comprising instructions which when executed on a computer perform any of the methods of Example Embodiments E1 to E24.

Example Embodiment E27. A computer program product comprising computer program, the computer program comprising instructions which when executed on a computer perform any of the methods of Example Embodiments E1 to E24.

Example Embodiment E28. A non-transitory computer readable medium storing instructions which when executed by a computer perform any of the methods of Example Embodiments E1 to E24.

### Group F Example Embodiments

Example Embodiment F1. A user equipment (UE) for receiving on-demand information associated with a synchronization signal block, the UE comprising: processing circuitry configured to perform any of the steps of any of the Group A and C Example Embodiments; and power supply circuitry configured to supply power to the processing circuitry.

Example Embodiment F2. A network node for transmitting on-demand information associated with a synchronization signal block, the network node comprising: processing circuitry configured to perform any of the steps of any of the Group B, D, and E Example Embodiments; power supply circuitry configured to supply power to the processing circuitry.

Example Embodiment F3. A user equipment (UE) for receiving on-demand information associated with a synchronization signal block, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, D, and E Example Embodiments to receive the user data from the UE for the host.

Example Embodiment F27. The method of the previous Example Embodiment, further comprising at the network node, transmitting the received user data to the host.

1. A method by a user equipment, UE, for receiving on-demand information, the UE served by a first network node associated with a first cell, the method comprising:
obtaining an indication of whether to request the on-demand information for a second cell from the first network node associated with the first cell or a second network node associated with the second cell;
based on the indication, transmitting, to the first network node or the second network node, a request for the on-demand information for the second cell; and
receiving the on-demand information for the second cell.

2. The method of claim 1, wherein obtaining the indication of whether to request the on-demand information from the first network node or the second network node comprises at least one of:
obtaining the indication from configuration information;
receiving a Master Information Block, MIB, from the second cell;
receiving a System Information Block, SIB, transmitted from the first cell.

3. The method of claim 1, wherein obtaining the indication of whether to request the on-demand information from the first network node or the second network node comprises at least one of:
identifying a characteristic of a reference signal received from the second cell;
receiving an indicator in a portion of a Synchronization Signal Block, SSB, received from the second cell;
receiving the SSB from the second cell;
receiving a broadcast message from the first network node;
detecting at least one reference signal from the second network node;
detecting at least one reference signal from the second network node that is associated with a quality level that is above a first threshold;
detecting at least one beam of the first cell that overlaps with the second cell;
detecting at least one beam of the first cell that overlaps with the second cell and is associated with a quality level that is above a second threshold; and
determining that a timer has expired, wherein the timer measures a time period since a previous request for SI for the second cell.

4. The method of claim 1 wherein:
the request is transmitted using at least one resource that is preconfigured for the UE;
the request is transmitted using at least one allocated resource that has been received from the first network node; or
the request is transmitted using at least one resource that has been received via higher layer signaling or L1/L2 signaling from the first network node.

5. The method of claim 1, wherein obtaining the indication comprises determining, based on at least one Synchronization Signal Block, SSB, configuration, SSB Measurement Timing Configuration, SMTC, and broadcast configuration of the first cell and/or the second cell that:
the UE is configured to receive at least one of:
periodic SSB;
System Information Block-1, SIB1;
Master Information Block, MIB;
or Other System Information, OSI, for the first cell, and
the UE is not configured to receive at least one of periodic SSB, SIB1, MIB, or OSI for the second cell.

6. The method of claim 1, wherein:
the request for the on-demand information is transmitted to the first network node associated with the first cell, and
the on-demand information is received from the second network node associated with the second cell.

7. The method of claim 6, wherein the on-demand information comprises at least one of:
a Synchronization Signal Block, SSB,
a Master Information Block, MIB,
a System Information Block-1, SIB1,
a System Information Block-2, SIB2,
a System Information Block-3, SIB3, and
Other System Information, OSI.

8. The method of claim 6, wherein the on-demand information is received via at least one beam indicated in the request or by the first network node.

9. The method of claim 1, wherein:
the request for the on-demand information is transmitted to the first network node associated with the first cell or the second network node associated with the second cell, and
the on-demand information is received from the first network node.

10. The method of claim 9, wherein the on-demand information comprises a partial or full Master Information Block, MIB, for the second cell.

11. The method of claim 9, wherein:
the on-demand information received from the first network node comprises at least one of:
a System Information Block-1, SIB1,
a System Information Block-2, SIB2,
a System Information Block-3, SIB3, and
Other System Information, OSI; and
the method comprises receiving a signal from the second network node associated with the second cell, the signal comprising a Synchronization Signal Block, SSB, for the second cell.

12. The method of claim 9, wherein:
the on-demand information received from the first network node comprises at least one of:
a Synchronization Signal Block, SSB,
a Master Information Block, MIB, and
a System Information Block-1, SIB1, and
the method further comprises receiving a signal from the second network associated with the second cell, the signal from the second network node comprising Other System Information, OSI, for the second cell.

13. The method of claim 9 wherein:
the on-demand information received from the first network node includes a System Information Block-1, SIB1, for the second cell, and
the method further comprises receiving a signal from the second network associated with the second cell, the signal from the second network node comprising a Synchronization Signal Block, SSB, and a Master Information Block, MIB, for the second cell.

14. The method of claim 9, wherein:
the on-demand information received from the first network node comprises a first portion of Other System Information, OSI, for the second cell, and
the method further comprises receiving a signal from the second network associated with the second cell, the signal from the second network node comprising a second portion of OSI for the second cell.

15. The method of claim 1, wherein prior to receiving the on-demand information for the second cell, the method comprises camping on the second cell.

16. The method of claim 1, comprising attempting to access the second cell, and wherein the on-demand information is received in response to attempting to access the second cell.

17-20. (canceled)

21. A method for transmitting on-demand information by a first network node associated with a first cell, the method comprising:
receiving a request for on-demand information for a second cell, the request being received from a User Equipment, UE, or a second network node associated with the second cell; and
performing at least one of:
transmitting the on-demand information for the second cell to the UE, and
transmitting, to the second network node associated with the second cell, an indication to send the on-demand information for the second cell to the UE.

22. The method of claim 21, comprising:
transmitting, to the UE, an indication of whether the UE is to request the on-demand information from the first network node or the second network node.

23. The method of claim 22, wherein the indication is transmitted to the UE via at least one of:
a System Information Block, SIB;
a broadcast message; and
a beam of the first cell that overlaps with the second cell.

24. The method of claim 22, wherein the indication is transmitted to the UE via at least one Synchronization Signal Block, SSB, configuration, SSB Measurement Timing Configuration, SMTC, and broadcast configuration and indicates at least one of:
the UE is configured to receive at least one of: periodic Synchronization Signal Block, SSB: System Information Block-1, SIB1; Master Information Block, MIB; or Other System Information, OSI, for the first cell, and
the UE is not configured to receive at least one of periodic SSB, SIB1, MIB, or OSI for the second cell.

25.-26. (canceled)

27. The method of claim 21, comprising transmitting, to the UE, higher layer signaling or L1/L2 signaling that indicates at least one resource, and wherein the request is received from the UE in the at least one resource.

28. The method of claim 21, wherein:
the request for the on-demand information is received from the UE; and
the first network node transmits the indication to the second network node based on receiving the request from the UE.

29. (canceled)

30. The method of claim 21, wherein:
the request for the on-demand information is received from the UE; and
the first network node transmits the on-demand information to the UE based on receiving the request from the UE.

31.-61. (canceled)

62. A user equipment, UE, for receiving on-demand information, the UE served by a first network node associated with a first cell, the UE adapted to:
obtain an indication of whether to request on-demand information for a second cell from the first network node associated with the first cell or a second network node associated with the second cell;
based on the indication, transmit, to the first network node or the second network node, a request for the on-demand information for the second cell; and
receive the on-demand information for the second cell.

63. (canceled)

64. A first network node associated with a first cell, the first network node for transmitting on-demand information, the first network node adapted to:
receive a request for on-demand information for a second cell, the request being received from a User Equipment, UE, or a second network node associated with the second cell; and
perform at least one of:
transmitting the on-demand information for the second cell to the UE, and
transmitting, to the second network node associated with the second cell, an indication to send the on-demand information for the second cell to the UE.

65. (canceled)

66. (canceled)

67. (canceled)
